(19) United States
(12) Patent Application Publication
(10) Pub. No.: US 2009/0245531 A1
(43) Pub. Date: Oct. 1, 2009

(54) Ear cover

(76) Inventor: Jimmy Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/078,354

(22) Filed: Mar. 31, 2008

(51) Int. Cl. H04R 3/02

(52) U.S. Cl. 381/73.1

(57) ABSTRACT

An ear cover includes a cover body and a chassis connected to the cover body so as to form a closed accommodating space. The closed accommodating space is provided therein with a filler, thereby isolating, buffering and absorbing the sound.

### BACKGROUND OF THE INVENTION

1. Field of the Invention

The present invention is related to an ear cover for isolating the sound.

2. Description of Related Art

In industrial manufacturing and product machining or in the working environment of other industries, loud sounds may be generated during work, making the ears of the worker uncomfortable, which reduces the working efficiency of the user and even cause permanent damage to the worker.

The conventional ear cover is provided with foam cotton that is connected to the ear cover and exposed to the outside. The foam cotton is used to isolate or absorb the sound. After a long-term use, the foam cotton is deteriorated easily to lose its original property, so that the effect of isolating or absorbing the sound is getting worse. As a result, the ear cover cannot isolate the sound efficiently.

Taiwan Patent Publication No. M312301 discloses an improved ear cover, which has a soft cover containing foam cotton. However, since the foam cotton is exposed to the outside and will be deteriorated easily after a long-term use, it also cannot isolate the sound efficiently.

Consequently, because of the above technical defects, the inventor keeps on carving unflaggingly through wholehearted experience and research to develop the present invention, which can effectively improve the defects described above.

### SUMMARY OF THE INVENTION

The object of the present invention is to provide an ear cover having a closed accommodating space therein. The closed accommodating space is provided therein with a filler so as to isolate the sound efficiently. Further, it will not be deteriorated after a long-term use.

For achieving the object described above, the present invention provides an ear cover comprising: a cover body and a chassis connected to the cover body so as to form a closed accommodating space, the closed accommodating space being provided therein with a filler.

The present invention has advantageous effects as follows.

(1) The filler of the ear cover is not exposed to the outside, so that it will not be deteriorated easily after a long-term use, thereby extending the lifetime.

(2) Since the filler of the ear cover is filled in the closed accommodating space that is formed by the cover body and the chassis and located within the ear cover, the ear cover can isolate the sound and protect the ears of the user efficiently irrespective of the operating manners of the user.

In order to further understand the characteristics and technical contents of the present invention, a detailed description is made with reference to the accompanying drawings. However, it should be understood that the drawings are illustrative only but not used to limit the present invention thereto.

### BRIEF DESCRIPTION OF THE DRAWINGS

FIG. 1 is a perspective view showing the external appearance of the ear cover of the present invention;

FIG. 2 is a perspective view showing the ear cover of the present invention;

FIG. 3 is a perspective view showing the external appearance of the ear cover of the present invention from another viewing angle;

FIG. 4 is a cross-sectional view showing the ear cover of the present invention; and

FIG. 5 is a cross-sectional view showing the ear cover of another embodiment of the present invention.

### DETAILED DESCRIPTION OF THE PREFERRED EMBODIMENTS

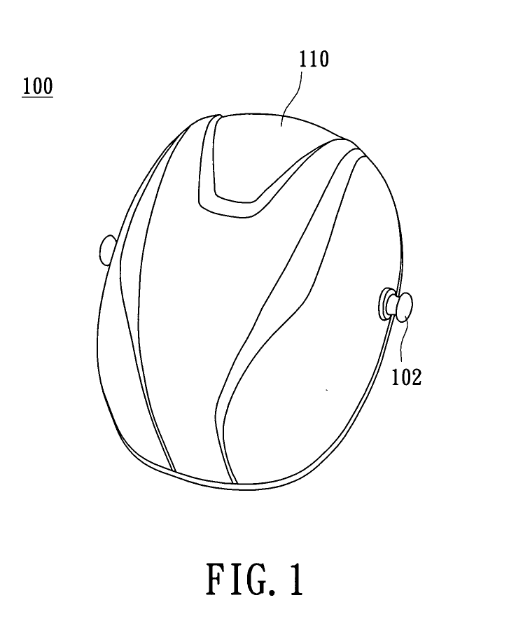

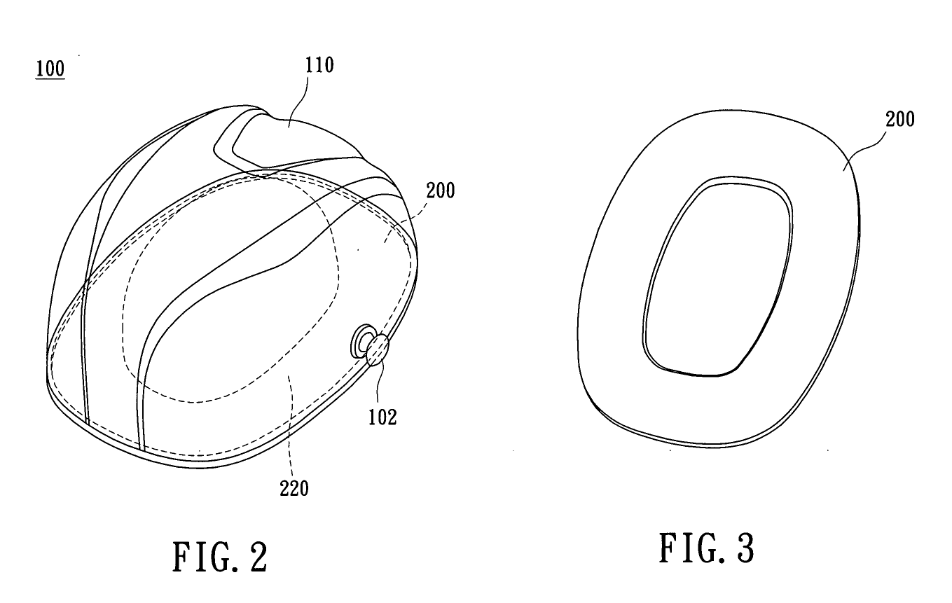

Please refer to FIGS. 1 to 5. The present invention is directed to an ear cover 100 comprising a cover body 110 and a chassis 200. The cover body 110 is made of plastics or other materials. The cover body 110 is a hollowed body with an opening on its bottom. The outside of the cover body 110 is provided with two connecting elements 102 that are located on two opposite sides of the cover body 110. In the present embodiment, the connecting element 102 is a pivot for connecting to other accessories (not shown).

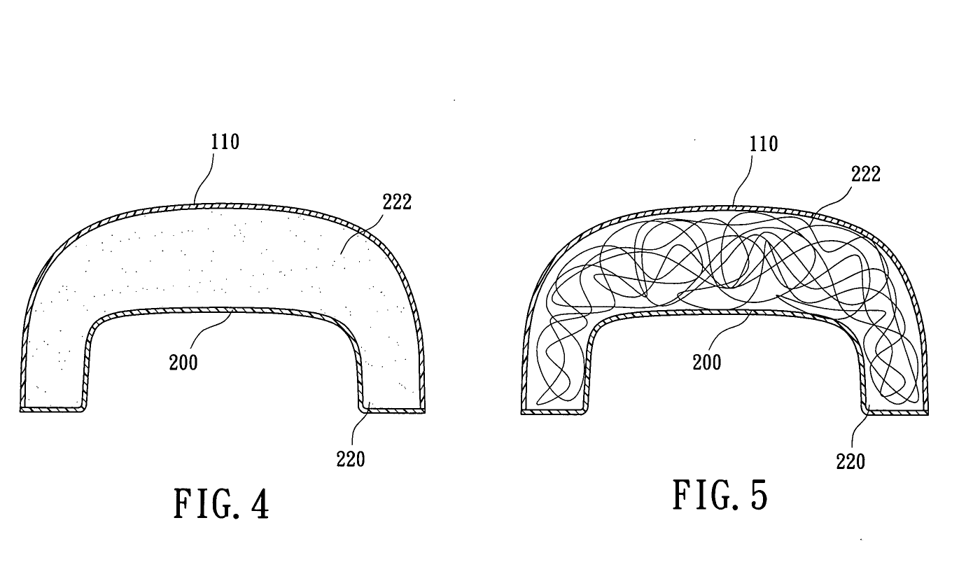

The chassis 200 is connected to the bottom of the cover body 110 so as to form a closed accommodating space 220. The closed accommodating space 220 is filled therein with a filler 222. The filler 222 is air or vacuum as shown in FIG. 4. The filler 222 can be made of a sound-absorbing piece as shown in FIG. 5, thereby isolating, buffering and absorbing the sound.

The filler 222 of the ear cover 100 of the present invention is not exposed to the outside, so that it will not be deteriorated easily after a long-term use, thereby extending the lifetime. Further, since the filler 222 of the ear cover 100 is filled in the closed accommodating space 220 that is formed by the cover body 110 and the chassis 200 and located within the ear cover 100, the ear cover can isolate the sound and protect the ears of the user efficiently irrespective of the operating manners of the user.

In view of the above detailed description, those skilled in this art can appreciate that the present invention really achieves the desired objects and conforms to the requirements for a utility model patent.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An ear cover, comprising:
a cover body; and
a chassis connected to the cover body so as to form a closed accommodating space, the closed accommodating space being provided therein with a filler.

2. The ear cover according to claim 1, wherein the filler is vacuum or air.

3. The ear cover according to claim 1, wherein the filler is a sound-absorbing piece.

4. The ear cover according to claim 1, wherein the outside of the cover body is provided with two connecting elements.
